(19) United States
(12) Patent Application Publication
(10) Pub. No.: US 2025/0100234 A1
(43) Pub. Date: Mar. 27, 2025

(54) RECYCLED GLASS IN SPRAY TRANSFER MOLDING

(71) Applicant: Magna Exteriors Inc., Aurora (CA)

(72) Inventors: Ranjit Pachha, Brampton (CA); Parvinder S. Walia, Shelby Township, MI (US); George Ettinger, Flint, MI (US); Axel Lachenmaier, Rudersberg (DE)

(73) Assignee: Magna Exteriors Inc., Aurora (CA)

(21) Appl. No.: 18/888,717

(22) Filed: Sep. 18, 2024

Related U.S. Application Data
(60) Provisional application No. 63/584,731, filed on Sep. 22, 2023.

(51) Int. Cl. B29C 70/12; B29B 17/02; B29B 17/04; B29C 70/42; B29K 75/00; B29K 105/12; B29K 309/08; B29L 31/08; B29L 31/30; B32B 5/02; B32B 5/26; C03C 25/26; C03C 25/40

(52) U.S. Cl. CPC B29C 70/12; B29B 17/02; B29B 17/04; B29C 70/42; B32B 5/022; B32B 5/265; C03C 25/26; C03C 25/40; B29B 2017/0496; B29K 2075/00; B29K 2105/128; B29K 2309/08; B29L 2031/085; B29L 2031/3005; B32B 2250/20; B32B 2255/02; B32B 2255/26; B32B 2260/021; B32B 2260/046; B32B 2262/101; B32B 2262/16; B32B 2605/00

(57) ABSTRACT

A process for fiberglass recovered from recycling of windmill or similar products at the end of lifecycle converted into a non-woven fiberglass mat and applying predetermined sizing. Sizing is applied to this fiberglass mat by spraying silane sizing on both sides of the mat. Recycled fiberglass content can be operably varied. Polyurethane resin can be sprayed onto either the recycled non-woven fiberglass mat alone or on a combination of recycled fiberglass mat and virgin fiberglass mat. This resin-impregnated mat is then placed onto a heated tool in a compression molding machine. Exemplary application of the recycled glass fiber mat is in electric vehicle composite battery cover and plug-in hybrid electric vehicle composite battery cover.

### CROSS-REFERENCE TO RELATED APPLICATIONS

This application is a Non-Provisional, which claims the benefit of U.S. Provisional Patent Application No. 63/584,731, filed Sep. 22, 2023. The disclosure of the above application is incorporated herein by reference.

### FIELD OF THE INVENTION

The present invention relates to a recycled glass fiber mat and spray transfer molding incorporating recycled fiber mat.

### BACKGROUND OF THE INVENTION

Original equipment manufacturers (OEM's) are increasingly looking to introduce recycled content in automotive parts. OEM's would also like to have an end-of-life solution for their parts, e.g., disposition/recycling of parts. Thermoset resin is a challenge to recycle and, even though thermoplastic resins can be recycled, there is a drop in mechanical properties upon recycling. Hence, either only a small amount of the resin products can be recycled, or the application has to be a downcycled lower-value application where mechanical properties are not critical.

Recycled glass has been used in small quantities in compounding thermoplastic compounds. Recycled glass is also being used by glass fiber manufacturers by melting it and then converting it back into fiber form. There is also a challenge in application of sizing in recycled fiber glass. Sizing is typically applied on glass rovings during their manufacturing process. Recycled glass is typically chopped fiberglass, making it a challenge in applying sizing.

During recycling of glass, any sizing is lost, and the recycled glass is obtained as chopped glass. Applying sizing to chopped glass is not currently being done due to the process complications. Therefore, in most cases, the recycled glass does not have sizing.

Recycled glass from burning or chemically stripping the resin also has the sizing removed. Handling small, recycled glass fibers and applying sizing is a major problem for commercial viability.

Accordingly, there remains a desire to provide predetermined recycled glass fiber in a predetermined amount and format and method for producing same, and incorporating recycled glass fiber into spray transfer molding and predetermined parts. Another objective of the present invention is to incorporate recycled fiber glass from large parts, e.g., windmills, into the production of predetermined automotive parts, e.g., such as automotive battery covers.

### SUMMARY OF THE INVENTION

Aspects of the present invention uses recycled glass fiber mat in spray transfer molding. Recycling glass content can be varied from about 5-100% of the reinforcement content, in accordance with the present invention. Application of the recycled glass fiber mat is operably suitable in predetermined parts, e.g., vehicle parts, automotive parts, composite battery electric vehicle (BEV) battery covers, plug-in hybrid electric vehicle (PHEV) battery covers, etc. A method to apply sizing on recycled glass fiber mat is provided according to aspects of the present invention.

The recycled chopped glass is operably converted into a mat and then predetermined sizing is applied. Having sizing on the recycled glass provides improved adhesion and thereby better mechanical properties. The sizing on the reinforcement also improves mechanical properties of composites.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 a flow chart illustrating recycled fiberglass in spray transfer molding, in accordance with aspects of the present invention;

FIG. 2 is a schematic of exemplary use of recycled fiberglass in spray transfer molding, in accordance with aspects of the present invention; and

FIG. 3 is a schematic of exemplary use of application of sizing on recycled glass fiber mat, in accordance with aspects of the present invention.

### DETAILED DESCRIPTION OF THE PREFERRED EMBODIMENTS

The following description of the preferred embodiment(s) is merely exemplary in nature and is in no way intended to limit the invention, its application, or uses.

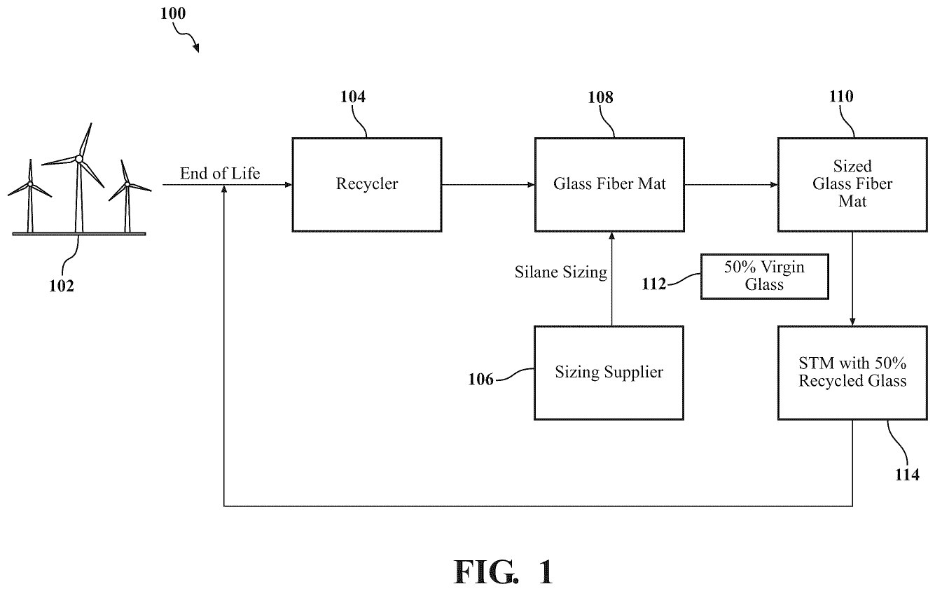

Referring to FIGS. 1-3 generally, initially, fiberglass recovered from recycling of a windmill or similar product, or any suitable product, at the end of its lifecycle is converted into a non-woven fiberglass mat. The step involves operably converting the end-of-life products into chopped fiber glass, e.g., through pyrolysis or combustion. The chopped fiber glass is then operably converted into non-woven mat.

A predetermined sizing is operably applied to this fiber glass mat, most preferably by spraying silane sizing on both sides of the mat. Sizing preferably forms about 0.2-1.0% by weight of the recycled fiber glass. The size solution preferably consists of a predetermined coupling agent, total solids, film former, additives and water. Preferably, the sizing solution includes a predetermined coupling agent (most preferably Organo silanes), about 1-20% of total solids, film former about 75-90% of total solids, additives about 2 to 7% (more preferably 5%) of total solid, and water about 90-95%.

The sized recycled fiber glass mat is used in different predetermined ratios with virgin fiberglass. Recycled fiber glass mat can vary from about 2.0% to 100% of total reinforcement when used in spray transfer molding.

At least one predetermined resin, preferably polyurethane resin, is used as a matrix for the spray transfer molding. Polyurethane resin is sprayed onto either a recycled non-woven fiberglass mat alone or in combination of recycled fiber glass mat and virgin fiberglass mat. This resin-impregnated mat is then placed onto a heated tool in the compression molding machine. Typical cycle time is preferably about 60 seconds and the pressure required is preferably about 200-500 psi. At the end of the predetermined cycle time, the press opens and the part is operably removed.

Using the recycled glass fiber mat along with the virgin glass fiber mat in the spray transfer molding, in accordance with aspects of the present invention, allows a large content of recycled material to be used in manufacturing automotive parts. There has been a challenge in application of sizing in the recycled fiberglass. Typically, sizing has been applied on glass rovings during their manufacturing process. Recycled glass is typically chopped fiberglass and hence the challenge of applying sizing. In accordance with aspects of the present invention, converting the chopped fibers into the non-woven mat makes is easier to apply the sizing either by a spray or dip process.

According to aspects of the present invention, there is provided a vehicle part, e.g., composite battery cover, incorporating the recycled fiberglass. In accordance with the present invention, there is provided recycled glass for and/or in predetermined strategic materials. In addition, there is provided spray transfer molding of the recycled fiberglass, in accordance with aspects of the present invention, including use of recycled glass fiber in spray transfer molding. There is also application of sizing on recycled glass fiber mats, according to aspects of the present invention.

In known usual manufacturing of fiberglass, the sizing is applied on the fiber as it extrudes out molten glass. Then this fiberglass is used for different applications (as a strand, woven, and non-woven mat). During the recycling of this glass, the sizing is lost, and the recycled glass is obtained as chopped glass. Applying sizing to chopped fiber is not currently being done due to the process complications. Hence currently in most of the cases, the recycled glass does not have sizing.

According to aspects of the present invention, in the process the recycled chopped glass is converted into a mat and then the sizing is applied. Having sizing on the recycled glass provides improved adhesion and thereby better mechanical properties. The sizing on the reinforcement improves mechanical properties of composites.

Recycled glass from burning or chemically stripping the resin also has the sizing removed. Handling small, recycled glass fibers and applying sizing is a major problem for commercial viability. Converting the recycled glass fibers into a mat in accordance with the present invention makes it easier to handle and transport. An aspect of the invention is to apply the sizing through a spray process. This is ideally suited for a spray transfer process where the glass mats are sprayed with a polyurethane before compression. This would be an additional step before that to enable improved bonding of recycled glass mat to polyurethan. The present invention provides improved performance with sizing sprayed glass mat versus one without that.

Referring to FIGS. 1-3 generally, and more particularly to FIG. 1, there is depicted a schematic of an exemplary recycling process and use of up to 100 percent recycled fiberglass in spray transfer molding, indicated generally at 100.

At the end of a product's life 102, e.g., such as a windmill or any suitable part, the product 102 is operably recycled, indicated at recycling step 104.

At least one predetermined sizing is provided, at 106, preferably, silane sizing. At least one glass fiber mat is operably provided at 108. The sizing 106 is operably applied to at least one recycled glass fiber mat 108, preferably operably sprayed on at least one side of the glass fiber mat, forming at least one sized glass fiber mat 110.

Preferably, at least one virgin glass mat is also provided, indicated at 112, preferably 50% virgin glass.

At step 114, spray transfer molding with about 50 percent recycled glass. Preferably, spray transfer molding incorporates spraying of glass fiber, e.g., the sized glass fiber mat 110, with liquid resin, most preferably, with liquid polyurethane resin

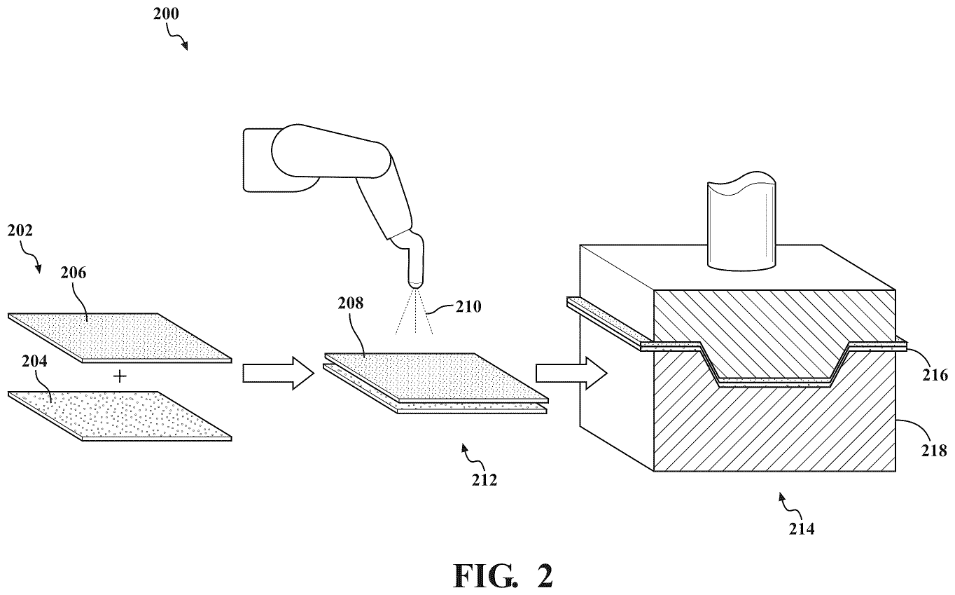

Referring to the Figures generally, and more particularly to FIG. 2, in accordance with aspects of the present invention, there is provided a spray transfer molding process, indicated generally at 200, including spraying of glass fiber with liquid resin, e.g., polyurethane resin. The ratio of resin to glass typically varies from about 30:70 to about 70:30. Preferably, the ratio of glass to resin is about 50:50.

The invention relates to using recycled fiber glass mat instead of virgin glass mat; preferably, operably incorporating both a recycled fiber glass mat and a virgin fiber glass mat, according to aspects of the present invention. The recycled glass content can be varied from about 100% recycled to about 5% or less. Preferably, about 50% of the fiberglass content can be recycled fiberglass and the other about 50% can be virgin glass. At least one predetermined mat is operably provided, indicated generally at 202, including a predetermined recycled fiber glass mat 204 and a predetermined virgin fiber glass mat 206, operably providing a fiber glass mat 208.

The fiber glass mat 208 is operably sprayed with a predetermined resin 210, as indicated generally at step 212, e.g., a polyurethane is operably sprayed on at least one side of the fiberglass mat 208.

As indicated at step 214, the polyurethane resin sprayed glass mat 216 is then operably loaded and cured for a predetermined time during compression molding in a press 218 to form a final part, e.g., battery cover.

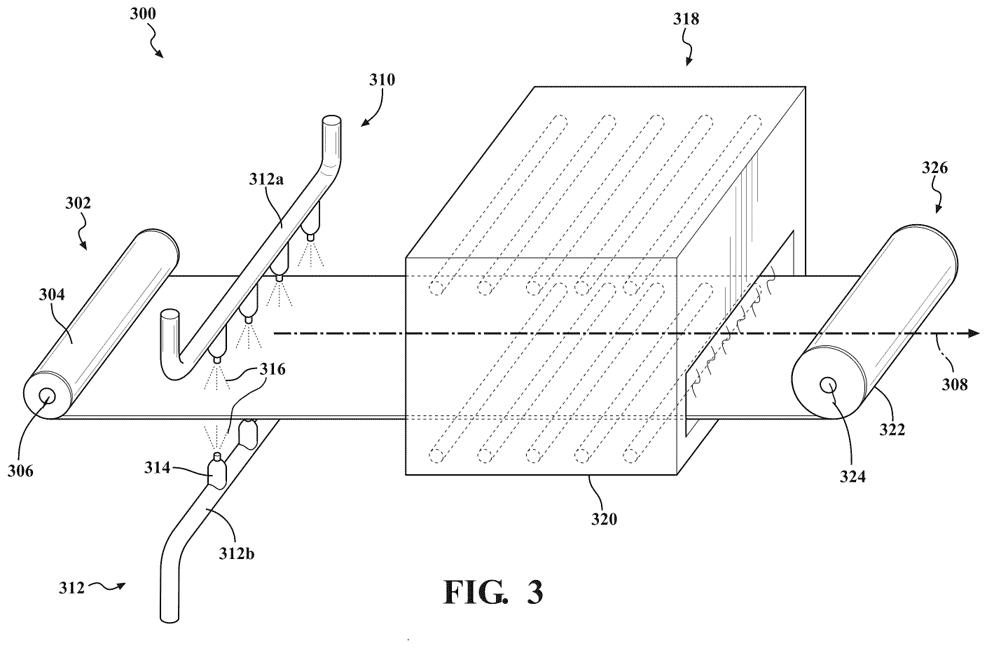

Referring to FIGS. 1-3 generally, and more particularly to FIG. 3, the application of sizing on a recycled fiberglass mat, indicated generally at 300, is provided in accordance with aspects of the present invention.

In accordance with the present invention, there is provided application of sizing on a recycled fiberglass mat. Preferably, sizing forms about 0.2-1.0% by weight of recycled glass mat and consists of coupling agent (organosilanes) 1-20% of solids, film former 75-90% of total solids, additive 5% of solids, and water (90-95%)

At a first step, indicated generally at 302, a recycled fiber glass mat 304 is operably unwound from a roll 306 on a processing line 308, where an exemplary advancing direction is generally indicated by an arrow, and operably advanced to a spraying step 310.

The line 308 includes at least one sprayer 312 including at least one nozzle 314, preferably, at least two spray banks 312a, 312b each with a plurality of nozzles 314, which are either a fixed spray nozzle heads or dynamic spray nozzle heads.

At the spraying step, indicated generally at 310, predetermined sizing 316 (preferably silane sizing) is sprayed on the recycled fiber glass mat 304 on to at least one surface of the mat 304, e.g., from top and/or bottom. Sizing spray is provided to at least one surface of the mat 304, e.g., top surface, from a first spray bank 312a, e.g., top bank, and/or a second surface of the bat 304, e.g., bottom surface, from the second bank 312b, e.g., bottom bank of nozzles 312b.

At a drying step, indicated generally at 318, the recycled fiber glass mat 304 with sizing 316 is then passed through an oven 320 for drying the sizing 316, thereby removing a predetermined amount of water and solvent from the sizing 316, and forming a sized recycled glass fiber mat 322.

The sized recycled glass fiber mat 322 is then operably wound on a roll 324. Rolling the recycled glass fiber mat with sizing is indicated generally at step 326.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A spray transfer molding process operably adapted for manufacturing vehicle parts, comprising:
providing a chopped fiber glass through recycling a predetermined product;
operably converting said chopped fiber glass into a non-woven mat;
operably applying a predetermined sizing to said non-woven mat;
operably drying said non-woven mat having said sizing to provide a sized recycled glass fiber mat;
providing a virgin fiber glass mat;
spraying a predetermined resin on at least said sized recycled glass fiber mat;
operably placing said sized recycled glass fiber mat that was resin sprayed and said virgin fiber glass mat into a compression mold; and
compression molding said sized recycled glass fiber mat and virgin fiber glass mat to form said vehicle part.

2. The process of claim 1, wherein said resin is a polyurethane.

3. The process of claim 1, further comprising the steps of:
operably placing said sized recycled glass fiber mat and said virgin fiber glass mat together to provide a fiber glass mat;
spraying said predetermined resin on said fiber glass mat;
placing said fiber glass mat that was sprayed into said compression mold; and
compression molding said fiber glass mat that was sprayed to form said vehicle part.

4. The process of claim 3, wherein said sized recycled fiber glass mat is used in predetermined ratio to said virgin fiber glass mat, wherein said recycled fiber glass mat can vary from about 2.0 percent to 100 percent of the total.

5. The process of claim 3, wherein said vehicle part comprises at least about 50 percent said sized recycled fiber glass mat.

6. The process of claim 1, wherein said vehicle part is an electric vehicle composite battery cover or plug-in hybrid electric vehicle composite battery cover.

7. The process of claim 1, wherein said chopped fiber glass is converted from windmills or predetermined large parts through pyrolysis or combustion into said chopped fiber glass.

8. The process of claim 1, wherein applying said predetermined sizing to both sides of said non-woven mat further includes providing at least one pair of sprayer banks with a plurality of sizing spray nozzles.

9. The process of claim 1, wherein operably drying said non-woven mat having said sizing to provide a sized recycled glass fiber mat further comprises providing an oven to remove at least a predetermined amount of water or solvent.

10. The process of claim 1, wherein said sized recycled glass fiber mat that was resin sprayed is operably placed onto a heated tool of said compression mold and is operably cured during said compression molding.

11. The process of claim 1, wherein said sizing is applied to said non-woven mat by spraying silane sizing on both sides of said non-woven mat, wherein said sizing forms about 0.2-1.0% by weight of said sized recycled fiber glass mat.

12. The process of claim 1, wherein said sizing is a solution comprising organosilanes in an amount of about 1-20 percent of total solid, film former in an amount about 75-90 percent of total solid, predetermined additives in an amount of about 5 percent total solid, and water.

13. A process for manufacturing a recycled glass fiber mat with sizing, comprising:
providing at least one recycled glass fiber mat;
providing at least one first sizing sprayer above said at least one recycled glass fiber mat;
providing at least one second sizing sprayer below said at least one recycled glass fiber mat;
providing at least one oven;
operably advancing said recycled glass fiber mat along a processing line;
spraying predetermined sizing from said at least one first and second sizing sprayers onto at least top and bottom surfaces of said recycled glass fiber mat;
operably advancing said recycled glass fiber mat with said sizing through said oven; and
drying the recycled glass fiber mat with said sizing within said oven to form said recycled glass fiber mat with sizing.

14. The process of claim 13, wherein said at least one recycled glass fiber mat is a non-woven fiberglass mat converted from chopped fiber glass, said non-woven mat allowing easier application of said sizing.

15. The process of claim 14, wherein said non-woven fiberglass mat includes said chopped fiber glass converted from operably recycling windmills through pyrolysis or combustion, said chopped fiber glass operably converted into said non-woven fiberglass mat.

16. The process of claim 13, wherein the first and second sizing sprayers incorporate at least one top spray bank and at least one bottom spray back, wherein each spray bank includes a plurality of nozzles which are a fixed spray nozzle heads, dynamic spray nozzle heads or a combination of fixed and dynamic spray nozzle heads.

17. The process of claim 13, further comprising providing at least one roll, wherein said recycled glass fiber mat is operably unwound from said at least one roll as said recycled glass fiber mat is advancing along said processing line.

18. The process of claim 13, wherein said sizing forms about 0.2-1.0% by weight of said recycled glass fiber mat with sizing.

19. The process of claim 13, wherein said sizing is a solution comprising organosilanes in an amount of about 1-20 percent of total solid, film former in an amount about 75-90 percent of total solid, predetermined additives in an amount of about 5 percent total solid, and water in an amount of about 90-96 percent of total solid.

20. The process of claim 13, wherein the sizing is a silane sizing.

21. The process of claim 13, wherein said oven is operable for drying said sizing for removing a predetermined amount of water and solvent.

22. The process of claim 13, wherein said recycled glass fiber mat with sizing is operably adapted for spray transfer molding in the production of an electric vehicle composite battery cover or plug-in hybrid electric vehicle composite battery cover.

23. A recycled glass fiber mat operably adapted for a vehicle part, comprising:
a non-woven fiberglass mat including recycled fiberglass recovered from recycling predetermined products; and
a predetermined sizing operably applied to the non-woven fiberglass mat,
wherein said vehicle part is an electric vehicle composite battery cover or plug-in hybrid electric vehicle composite battery cover.

24. The recycled glass fiber mat of claim 23, wherein said non-woven mat operably incorporates at least chopped fiber glass, wherein said non-woven mat allows easier application of said sizing by spray or dip processes.

25. The recycled glass fiber mat of claim 23, wherein said sizing is silane sizing.

26. The recycled glass fiber mat of claim 23, wherein a predetermined amount of said sizing is operably sprayed on both sides of the non-woven fiberglass mat.

27. The recycled glass fiber mat of claim 23, wherein said sizing forms about 0.2-1.0% by weight of the recycled fiber glass.

28. The recycled glass fiber mat of claim 23, wherein said sizing is a solution consisting of a predetermined coupling agent, predetermined film former, predetermined additives, and water.

29. The recycled glass fiber mat of claim 23, wherein said sizing is a solution comprising organosilanes in an amount of about 1-20 percent of total solid, film former in an amount about 75-90 percent of total solid, predetermined additives in an amount of about 5 percent total solid, and water in an amount of about 90-96 percent of total solid.

30. The recycled glass fiber mat of claim 23, wherein said sizing on said non-woven fiberglass mat is operably dried to provide said recycled glass fiber mat.
